(19) United States
(12) Patent Application Publication
(10) Pub. No.: US 2015/0124977 A1
(43) Pub. Date: May 7, 2015

(54) HEADSET IN-USE DETECTOR

(71) Applicant: QUALCOMM Incorporated, San Diego, CA (US)

(72) Inventors: Ankit Srivastava, San Diego, CA (US); Hyun Jin Park, San Diego, CA (US); Guoqing Miao, San Diego, CA (US)

(73) Assignee: QUALCOMM Incorporated, San Diego, CA (US)

(21) Appl. No.: 14/074,593

(22) Filed: Nov. 7, 2013

(51) Int. Cl. H04R 29/00; H04R 1/10

(52) U.S. Cl. CPC H04R 29/00; H04R 1/1091
USPC 381/58

(57) ABSTRACT

A headset in-use detector is disclosed. In an exemplary embodiment, an apparatus includes a detector configured to receive a sound signal and an echo signal and generate a detection signal, and a controller configured to determine whether or not a headset is in-use based on the detection signal.

### BACKGROUND

1. Field

The present application relates generally to the operation and design of audio headsets, and more particularly, to a headset in-use detector for use with audio headsets.

2. Background

There is an increasing demand to provide high quality audio and video from a variety of user devices. For example, handheld devices are now capable of rendering high definition video and outputting high quality multichannel audio. Such devices typically utilize audio amplifiers to provide high quality audio signal amplification to allow an audio signal to be reproduced by a headset worn by a user. In a wireless device, audio amplification may utilize significant battery power and thereby reduce operating times.

If the headset is not utilized (e.g. a headset is not being worn by a user), the device providing the amplified sound signal to the headset continues to operate thus wasting battery power. It would be desirable to know when a headset is not being utilized so that power saving techniques can be implemented. For example, when a headset is not being worn by a user, a pause in sound reproduction can be implemented or a reduced power mode can be implemented to save battery power.

### BRIEF DESCRIPTION OF THE DRAWINGS

The foregoing aspects described herein will become more readily apparent by reference to the following description when taken in conjunction with the accompanying drawings wherein:

FIG. 1 shows an exemplary embodiment of a novel headset in-use detector configured to detect when a headset is being utilized;

FIG. 2 shows a detailed exemplary embodiment of a headset in-use detector configured to detect when a headset is being utilized;

FIG. 3 shows an exemplary embodiment of a method for headset detection;

FIG. 4 shows a detailed exemplary embodiment of a headset in-use detector configured to detect when a headset is being utilized;

FIG. 5 shows an exemplary embodiment of a method for headset detection;

FIG. 6 shows an exemplary embodiment of a headset in-use detector apparatus configured to detect when a headset is being utilized; and

FIG. 7 shows an exemplary embodiment of a headset in-use detector apparatus configured to detect when a headset is being utilized.

### DETAILED DESCRIPTION

The detailed description set forth below in connection with the appended drawings is intended as a description of exemplary embodiments of the invention and is not intended to represent the only embodiments in which the invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

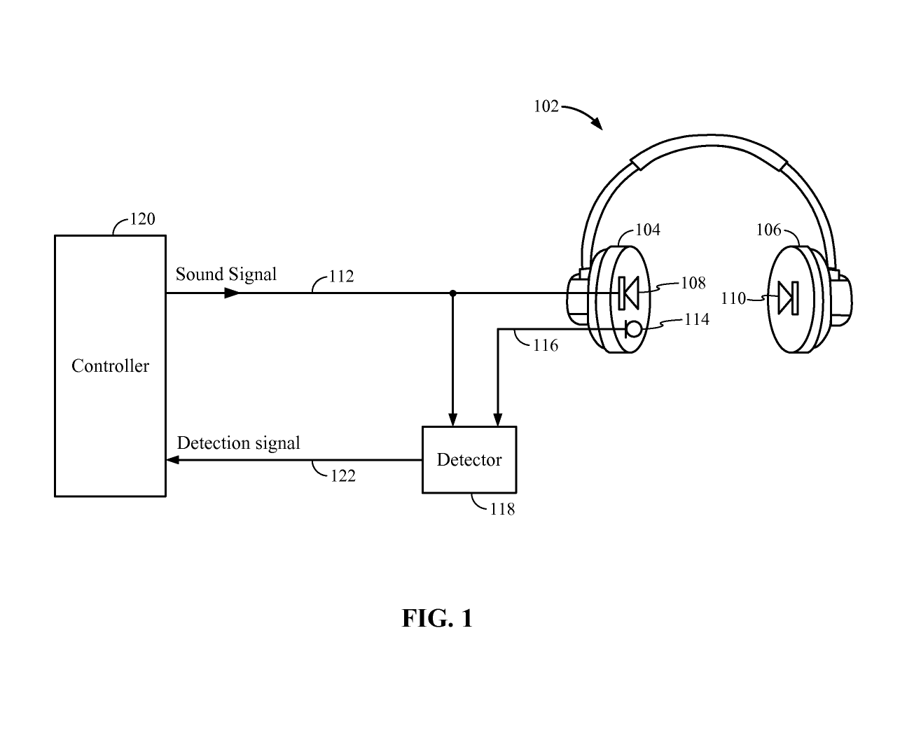

FIG. 1 shows an exemplary embodiment of a novel headset in-use detector 118 configured to detect when a headset 102 is being utilized by a user. In an exemplary embodiment, the headset 102 is a noise cancelling headset that has ear cups 104 and 106. The ear cups 104 and 106 include speakers 108 and 110, respectively, to reproduce a sound signal 112. For example, in an exemplary embodiment, the sound signal 112 is generated by a controller 120. At least one of the ear cups includes a microphone, such as microphone 114. In one implementation, the microphone 114 is configured to detect ambient or environmental noise that can be canceled or removed from the sound signal 112 to improve the sound quality experienced by the user when wearing the headset.

During operation, the microphone 114 outputs an echo signal 116. The echo signal 116 includes not only ambient or environmental sounds but also includes artifacts of the sound signal 112. For example, the audio reproductions of the sound signal 112 by the speakers 108 and 110 may result in some or all of the sound signal 112 being received by the microphone 114 as part of the echo signal. In an exemplary embodiment, the sound characteristics of the echo signal 116 change based on whether or not the headset is being worn by the user. For example, given a particular sound signal 112, when the headset 102 is being worn by a user, the echo signal 116 has selected sound characteristics that are different from the sound characteristics that result when the headset is not being worn by the user. In an exemplary embodiment, the sound characteristics of the echo signal 116 change due to the proximity of the ear cups 104, 106 to the user's head.

A detector 118 operates to receive both the sound signal 112 and the echo signal 116 and performs various processing to determine if the headset is being worn by the user. A detection signal 122 is provided to the controller 120 to indicate whether or not the headset 102 is being worn by the user. If the detector 118 determines that the headset 102 is not being worn by the user, the controller 120 may optionally discontinue the sound signal 112, pause the sound signal, or reduce the power of the sound signal 112 so as to reduce overall power consumption.

It should be noted that although in the exemplary implementation shown in FIG. 1, the detector 118 is shown as a stand alone device, in other exemplary implementations the features and functions of the detector 118 may be included, incorporated, and/or integrated into either or both of the headset 102 and/or the controller 120. A more detailed description of exemplary embodiments of the headset in-use detector 118 is provided below.

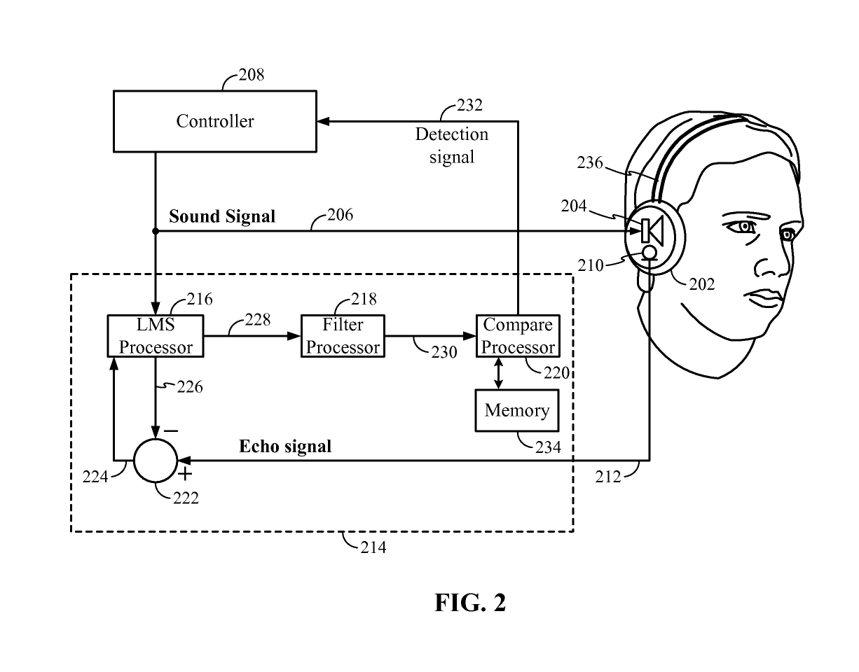

FIG. 2 shows a detailed exemplary embodiment of a headset in-use detector 214 configured to detect when a headset 236 is being worn by a user. In an exemplary embodiment, the headset 236 comprises a noise cancelling headset that includes ear cup 202 having a speaker 204 to reproduce a sound signal 206. For example, in an exemplary embodiment, the sound signal 206 is generated by a controller 208. The ear cup 202 includes a microphone 210 to detect ambient or environmental noise that can be canceled or removed from the sound signal 206.

During operation, the microphone 210 outputs an echo signal 212 that comprises aspects of a particular sound signal 206 output from a controller 208. The echo signal 212 is different based on whether or not the headset is being worn by the user. The detector 214 operates to make this determination and comprises a least mean square (LMS) processor 216, a filter processor 218, a compare processor 220, memory 234, and signal combiner 222.

The LMS processor 216 comprises analog and/or digital circuitry, hardware and/or hardware executing software and is configured to perform an adaptive LMS algorithm. The LMS processor 216 receives the sound signal 206 and an error signal 224. The error signal 224 is generated by the signal combiner 222 by subtracting an output 226 of the LMS processor 216 from the echo signal 212. The signal combiner 222 comprises any suitable hardware or hardware executing software to perform the signal combining function. The LMS processor 216 adapts an acoustic transfer function until the error signal 224 is minimized The acoustic transfer function 228 generated by the LMS processor 216 is input to the filter processor 218, which filters the transfer function to produce a filtered output 230 that is input to the comparator 220. The filter processor 218 comprises analog and/or digital circuitry, hardware and/or hardware executing software and is configured to perform a filtering function.

The compare processor 220 comprises analog and/or digital circuitry, hardware and/or hardware executing software and is configured to perform a comparing function. The compare processor 220 is connected to memory 234, which is used to store and retrieve information for use by the compare processor 220. For example, the memory 234 may store acoustic properties of the headset that are used to generate the detection signal 232. The compare processor 220 detects whether or not the headset is being worn by a user by comparing the filtered output 230 to a pre-stored transfer function (i.e., a reference transfer function stored in the memory 234) associated with the headset 236 when worn. In another embodiment, the comparator 220 compares the filtered transfer function 230 to a previously stored transfer function (i.e., a reference transfer function based on the acoustic properties of the headset 236 stored in the memory 234) to detect a change that indicates whether or not the headset 236 is being worn by a user. For example, certain characteristics and/or aspects of the transfer function indicate that the headset 236 is being worn and these characteristics and/or aspects are detected by the compare processor 220.

A detection signal 232 is then generated by the compare processor 220 that indicates the status of the headset 236. The detection signal 232 is input to the controller 208, which may adjust the sound signal 206 based on the detection signal 232. For example, the sound signal 206 may be terminated, paused, or reduced in power by the controller 208 based on the detection signal 232 to reduce power consumption. It should also be noted that the controller 208 is configured to output control signals (not shown) that are used to control all of the functional elements shown in FIG. 2.

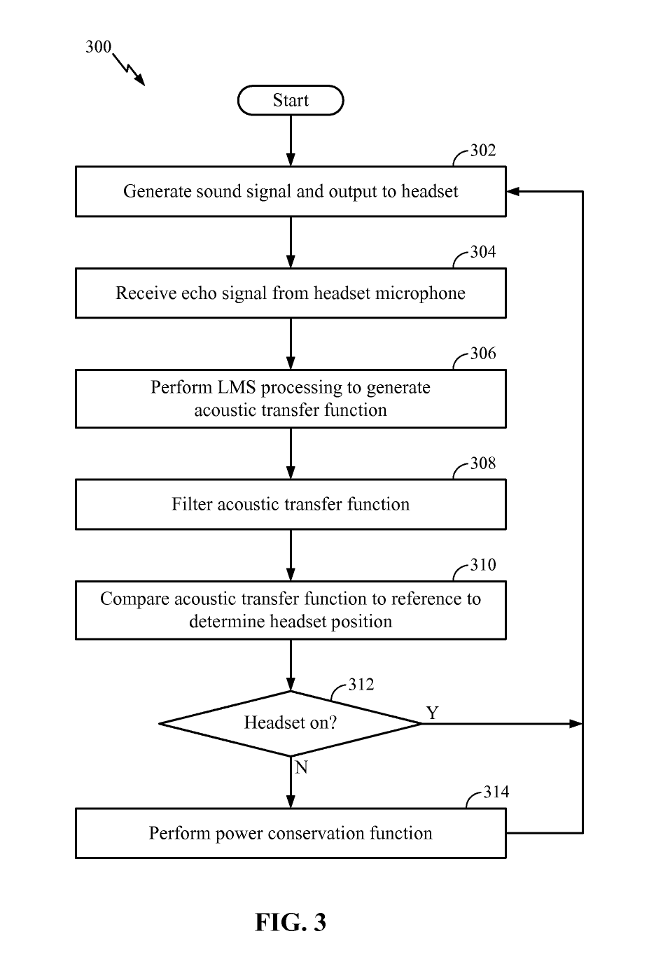

FIG. 3 shows an exemplary embodiment of a method 300 for headset detection. For example, the method 300 is suitable for use with the headset in-use detector 214 shown in FIG. 2.

At block 302, a sound signal is generated and output to a headset. For example, the controller 208 generates the sound signal 206 and outputs it to the headset 236 where it is received by the ear cup 202.

At block 304, an echo signal is received from the headset. For example, the speaker 204 in the ear cup 202 amplifies the sound signal 206 and the microphone 210 picks up ambient and environmental sounds that include aspects (or artifact) of the sound signal. The microphone 210 then generates the echo signal 212 that comprises sound characteristics that indicate whether or not the headset 236 is being worn by a user.

At block 306, an acoustic transfer function is generated using LMS processing. For example, the LMS processor 216 generates an acoustic transfer function based on the sound signal 206 and the echo signal 212.

At block 308, the acoustic transfer function is filtered to generate a filtered transfer function. For example, the filter processor 218 operates to filter the acoustic transfer function to generate a filtered transfer function 230.

At block 310, a comparison is performed to compare the filtered acoustic transfer function to a reference transfer function. For example, the compare processor 220 makes the comparison. In an exemplary embodiment, the reference transfer function is a predetermined transfer function associated with the headset 236 that is stored in the memory 234. In another exemplary embodiment, the reference transfer function is a prior transfer function that was stored in the memory 234. The compare processor 220 outputs the detection signal 232 based on the comparison.

At block 312, a determination is made as to whether or not the headset 236 is being worn by a user. For example, the processor 208 makes this determination based on the detection signal 232. If it is determined that the headset 236 is being worn by the user, the method proceeds to block 302. If it is determined that the headset is not “in-use” (i.e., not being worn by the user) the method proceeds to block 314.

At block 314, power conservation functions are performed since it has been determined that the headset 236 is not being worn by a user. For example, the processor 208 performs power conservation functions that include, but are not limited to, reducing power of the sound signal 206, pausing the sound signal 206, or totaling disabling the sound signal 206.

Thus, the method 300 performs headset detection to determine when a headset is “in-use” (i.e., being worn by a user). It should be noted that the operations of the method 300 may be rearranged or modified such that other embodiments are possible.

### First Alternative Headset “In-Use” Detector

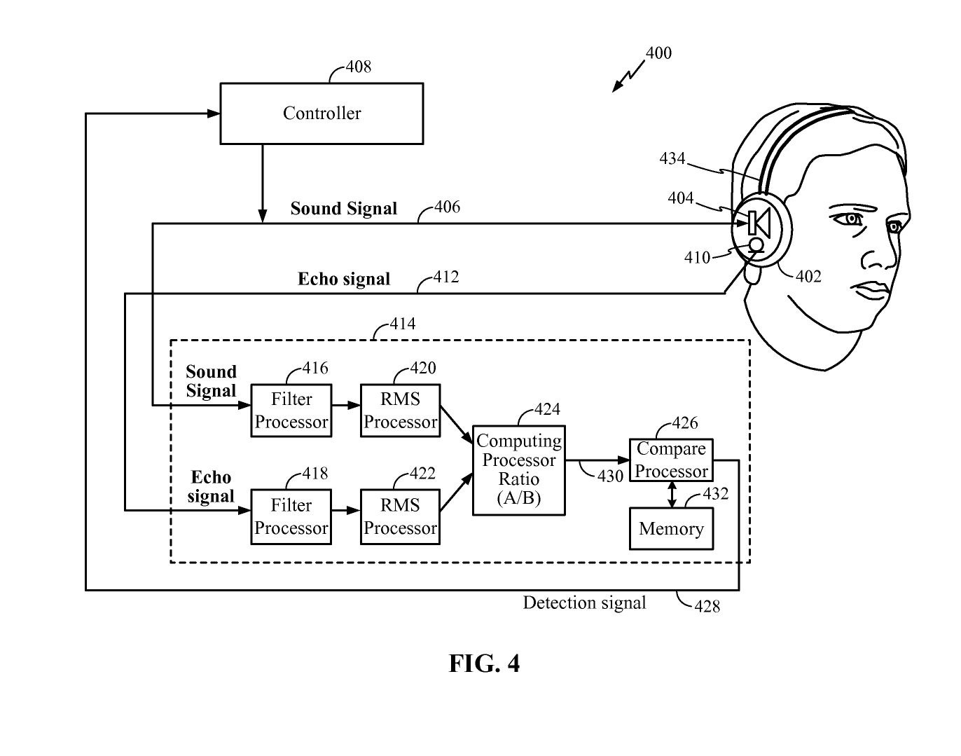

FIG. 4 shows a detailed exemplary alternative embodiment of a headset in-use detector 400 configured to detect when a headset 434 is being worn by a user. In an exemplary embodiment, the headset 434 comprises a noise cancelling headset that includes ear cup 402 having a speaker 404 to reproduce a sound signal 406. For example, in an exemplary embodiment, the sound signal 406 is generated by a controller 408. The ear cup 402 includes a microphone 410 to detect ambient or environmental noise that can be canceled or removed from the sound signal 406.

During operation, the microphone 410 outputs an echo signal 412 that comprises aspects of a particular sound signal 406 output from a controller 408. The echo signal 412 has different sound characteristics based on whether or not the headset 434 is being worn by the user. A detector 414 operates to make this determination and comprises filter processors 416, 418, RMS processors 420, 422, and computing processor 424. A compare processor 426 compares the output of the calculator and generates a detection signal 428 to the controller 408.

The filter processors 416 and 418 operate to filter the sound signal 406 and the echo signal 412 and provide filtered signals to the RMS processors 420 and 422. The RMS processors 420 and 422 operate to calculate the RMS power of the filtered sound signal and echo signal. The RMS powers output from the RMS processors 420 and 422 are input to the computing processor 424 that determines a power ratio 430. The power ratio 430 is input to the compare processor 426 that compares the power ratio to a known threshold that is stored in a memory 432. The output of the comparison is a detection signal 428 that indicates whether or not the user is wearing the headset 434.

The detection signal 428 is input to the controller 408, which may adjust the sound signal 406 based on the detection signal 428. For example, the sound signal 406 may be terminated, paused or reduced in power by the controller 408 based on the detection signal 428.

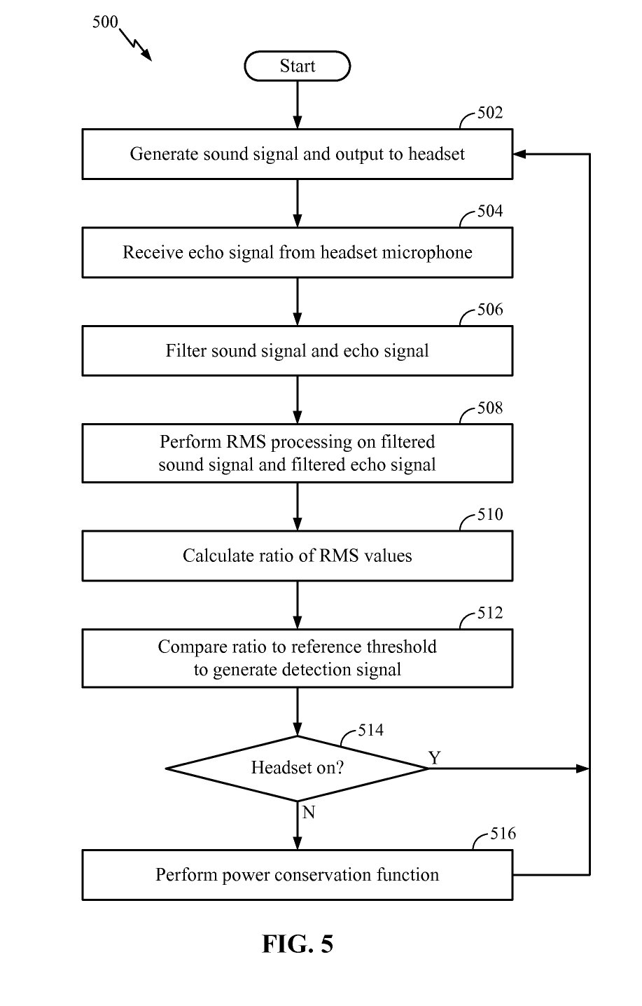

FIG. 5 shows an exemplary embodiment of a method 500 for headset detection. For example, the method 500 is suitable for use with the headset in-use detector 400 shown in FIG. 4.

At block 502, a sound signal is generated and output to a headset. For example, the controller 408 generates the sound signal 406 and outputs it to the ear cup 402 of the headset 434.

At block 504, an echo signal is received from the headset. For example, the speaker 404 in the ear cup 402 produces an audio version of the sound signal 406 and the microphone 410 picks up ambient and environmental sounds that include aspects of the audio sound signal. The microphone 410 then generates the echo signal 412 that comprises sound characteristics that indicate whether or not the headset is being worn by a user.

At block 506, the sound signal and echo signal are filtered. For example, the filter processors 416 and 418 operate to filter the sound signal and the echo signal.

At block 508, RMS processing is performed. For example, the RMS processors 420 and 422 operate to perform RMS processing on the filtered sound signal and echo signal to determine associated power values.

At block 510, a calculation is performed to determine the ratio of the RMS values of the sound signal and the echo signal. In an exemplary embodiment, the computing processor 424 operates to determine this ratio 430 and outputs the ratio 430 to the compare processor 426.

At block 512, a comparison of the ratio to a selected threshold value is performed. For example, the computing processor 426 performs this comparison to generate the detection signal 428 that is input to the controller 408. In an exemplary embodiment, the computing processor 426 obtains the threshold value (i.e., a selected power level) from the memory 432.

At block 514, a determination is made as to whether the headset is being worn by a user. For example, the controller 408 makes this determination based on the detection signal 428. If it is determined that the user is wearing the headset, the method proceeds to block 502. If it is determined that the user is not wearing the headset, the method proceeds to block 516. For example, in an exemplary embodiment, the detection signal 428 indicates whether the ratio exceeds the threshold value, and if so, the controller 408 determines that the headset is “in-use” and being worn by the user.

At block 516, power conservation functions are performed since it has been determined that the headset is not being worn by a user. For example, the controller 408 performs the power conservation functions that include, but are not limited to, reducing power of the sound signal, pausing the sound signal or totaling disabling the sound signal.

Thus, the method 500 performs headset detection to determine when a headset is being worn by a user. It should be noted that the operations of the method 500 may be rearranged or modified such that other embodiments are possible.

### Second Alternative Headset In-Use Detector

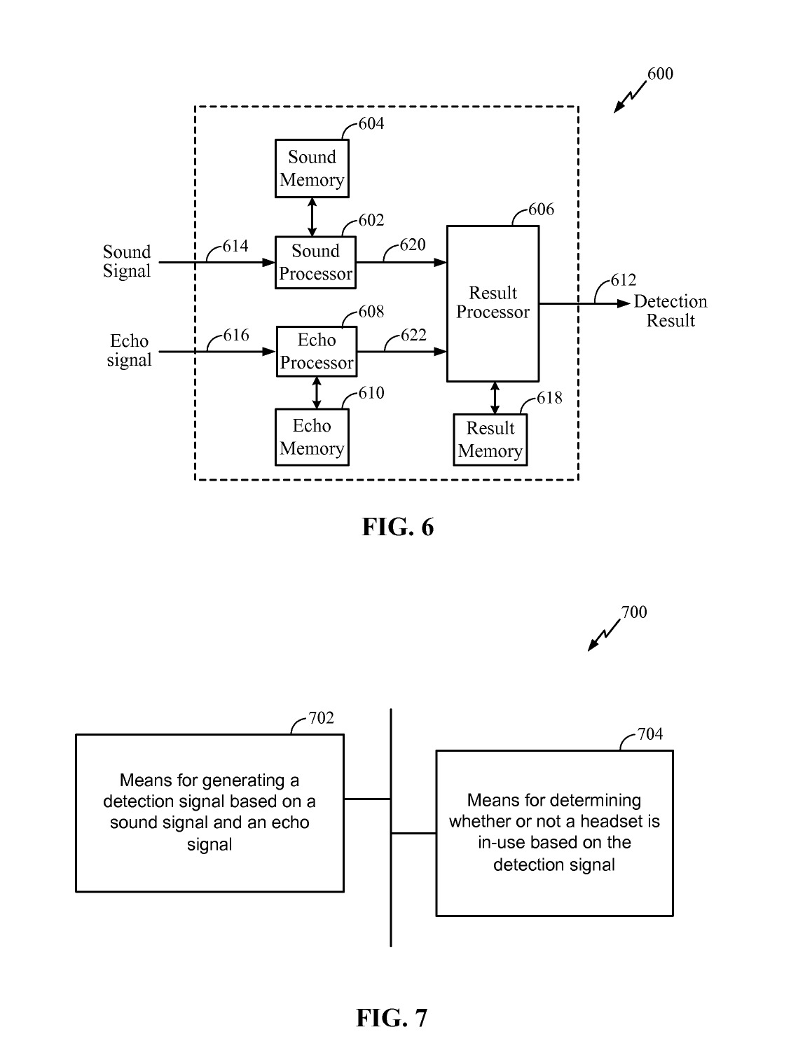

FIG. 6 shows a detailed exemplary embodiment of a headset in-use detector 600 configured to detect when a headset is being utilized. For example, the detector 600 is suitable for use as the detector 214 shown in FIG. 2. In an exemplary embodiment, the detector 600 receives a sound signal 614 and a corresponding echo signal 616 and outputs a detection signal 612 that indicates whether or not a headset is in-use. For example, the sound signal 614 may be the sound signal 206 shown in FIG. 2, and the echo signal 616 may be the echo signal 212 shown in FIG. 2. In various exemplary embodiments, the processing of the sound signal 614 and/or the echo signal 612 may be performed in analog or digital form.

During operation, the sound signal 614 is received by a sound processor 602 that comprises at least one of a CPU, gate array, discreet logic, analog to digital convertor, digital to analog convertor, analog circuitry or other hardware and/or hardware executing software. The processor 602 operates to perform any type of processing on the sound signal 614. For example, the processing includes but is not limited to filtering, scaling, amplifying, or any other suitable processing. The sound processor 602 is connected to a sound memory 604 that is configured to store information for use by the sound processor 602. For example, the sound memory 604 may store sound information, processed sound information, processing parameters, reference values, headset calibration information, processing history, and/or any other information. The sound processor 602 outputs a processed sound signal 620 to a result processor 606. Thus, the sound processor 602 is configured to perform any desired processing (including a simple pass-through with no processing) on the sound signal 614 to generate the processed sound signal 620. In an exemplary embodiment, the sound processor 602 simply outputs the unprocessed sound signal 614 as the processed sound signal 620.

The echo signal 616 is received by an echo processor 608 that comprises at least one of a CPU, gate array, discreet logic, analog to digital convertor, digital to analog convertor, analog circuitry or other hardware and/or hardware executing software. The processor 608 operates to perform any type of processing on the echo signal 616. For example, the processing includes but is not limited to filtering, scaling, amplifying, or any other suitable processing. The echo processor 608 is connected to an echo memory 610 that is configured to store information for use by the echo processor 608. For example, the echo memory 610 may store sound information, processed sound information, processing parameters, reference values, headset calibration information, processing history, and/or any other information. The echo processor 608 outputs a processed echo signal 622 to the result processor 606. Thus, the echo processor 608 is configured to perform any desired processing (including a simple pass-through with no processing) on the echo signal 616 to generate the processed echo signal 622. In an exemplary embodiment, the echo processor 608 simply outputs the unprocessed echo signal 616 as the processed echo signal 622.

The processed sound signal 620 and the processed echo signal 622 are received by the result processor 606 that comprises at least one of a CPU, gate array, discreet logic, analog to digital convertor, digital to analog convertor, analog circuitry or other hardware and/or hardware executing software. The processor 606 operates to perform any type of processing on the processed sound signal 620 and the processed echo signal 622 to generate a detection result 612 that indicates whether or not the headset is in-use. For example, the processing includes but is not limited to filtering, scaling, amplifying, combining, power detection, comparing to each other, comparing to one or more references or any other suitable processing to determine whether or not the headset is “in-use” and to generate the detection result 612 to indicate that determination. The result processor 606 is connected to a result memory 618 that is configured to store information for use by the result processor 606. For example, the result memory 618 may store sound and/or echo information, processed sound and/or echo information, processing parameters, reference values, headset calibration information, processing history, previous calculations or results, and/or any other information. The result processor 606 may use the information stored in the memory 618 to determine the detection result signal 612. The result processor 606 outputs the detection result signal 612 to another processing entity. For example, in an exemplary embodiment, the detection result signal 612 is input to the controller 208, which may adjust the sound signal 614 based on the detection result signal 612. For example, if the detection result signal 612 indicates that the headset is not in-use, the controller 208 may adjust the sound signal 614, such as by terminating it or reducing power to reduce power consumption while the headset is not in-use. The controller 208 may perform any type of function based on the status of the detection result signal 612.

Accordingly, the detector 600 comprises a first processor 602 configured to receive a sound signal and generate a processed sound signal, a second processor 608 configured to receive an echo signal and generate a processed echo signal, and a third processor 606 configured to generate a detection signal the indicates whether or not a headset is in-use based on processing at least one of the processed sound signal and the processed echo signal.

FIG. 7 shows a headset in-use detector apparatus 700 configured to detect when a headset is being utilized. For example, the apparatus 700 is suitable for use as the detector 214 shown in FIG. 2. In an aspect, the apparatus 700 is implemented by one or more modules configured to provide the functions as described herein. For example, in an aspect, each module comprises hardware and/or hardware executing software.

The apparatus 700 comprises a first module comprising means (702) for generating a detection signal based on a sound signal and an echo signal, which in an aspect comprises the detector 214.

The apparatus 700 also comprises a second module comprising means (704) for determining whether or not a headset is in-use based on the detection signal, which in an aspect comprises the controller 208.

Those of skill in the art would understand that information and signals may be represented or processed using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. It is further noted that transistor types and technologies may be substituted, rearranged or otherwise modified to achieve the same results. For example, circuits shown utilizing PMOS transistors may be modified to use NMOS transistors and vice versa. Thus, the amplifiers disclosed herein may be realized using a variety of transistor types and technologies and are not limited to those transistor types and technologies illustrated in the Drawings. For example, transistors types such as BJT, GaAs, MOSFET or any other transistor technology may be used.

Those of skill would further appreciate that the various illustrative logical blocks, modules, circuits, and algorithm steps described in connection with the embodiments disclosed herein may be implemented as electronic hardware, computer software executed by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both non-transitory computer storage media and communication media including any medium that facilitates transfer of a computer program from one place to another. A non-transitory storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The description of the disclosed exemplary embodiments is provided to enable any person skilled in the art to make or use the invention. Various modifications to these exemplary embodiments will be readily apparent to those skilled in the art, and the generic principles defined herein may be applied to other embodiments without departing from the spirit or scope of the invention. Thus, the invention is not intended to be limited to the exemplary embodiments shown herein but is to be accorded the widest scope consistent with the principles and novel features disclosed herein.

What is claimed is:

1. An apparatus comprising:
a detector configured to receive a sound signal and an echo signal and generate a detection signal; and
a controller configured to determine whether or not a headset is in-use based on the detection signal.

2. The apparatus of claim 1, further comprising a microphone configured to generated the echo signal from on an acoustic version of the sound signal that is generate by the headset.

3. The apparatus of claim 1, the detector comprising:
a processor configured to generate an acoustic transfer function;
a filter processor configured to filter the acoustic transfer function to generate a filtered acoustic transfer function; and
a compare processor configured to compare the filtered acoustic transfer function to a reference to generate the detection signal.

4. The apparatus of claim 3, the processor configured to perform a least mean square (LMS) operation to generate the acoustic transfer function.

5. The apparatus of claim 3, the reference determined from acoustic properties of the headset that are stored in a memory.

6. The apparatus of claim 3, the reference comprising a previously determined acoustic transfer function that is stored in a memory.

7. The apparatus of claim 1, the detector comprising:
a processor configured to generate power values for the sound signal and the echo signal;
a computing processor configured to determine a ratio of the power values; and
a compare processor configured to compare the ratio to a reference to generate the detection signal.

8. The apparatus of claim 7, the processor configured to calculate root mean square (RMS) values for the power values of the sound signal and the echo signal.

9. The apparatus of claim 8, the computing processor configured to generate the ratio by dividing the RMS values.

10. The apparatus of claim 7, the reference is a selected power level.

11. An apparatus comprising:
means for generating a detection signal based on a sound signal and an echo signal; and
means for determining whether or not a headset is in-use based on the detection signal.

12. The apparatus of claim 11, further comprising means for generating the echo signal from an acoustic version of the sound signal that is generated by the headset.

13. The apparatus of claim 11, the means for generating the detection signal comprising:
means for generating an acoustic transfer function;
means for filtering the acoustic transfer function to generate a filtered acoustic transfer function; and
means for comparing the filtered acoustic transfer function to a reference to generate the detection signal.

14. The apparatus of claim 13, the means for generating the acoustic transfer function configured to perform a least mean square (LMS) operation to generate the acoustic transfer function.

15. The apparatus of claim 11, the reference determined from acoustic properties of the headset that are stored in a memory.

16. The apparatus of claim 11, the reference comprising a previously determined acoustic transfer function that is stored in a memory.

17. The apparatus of claim 11, the means for generating the detection signal comprising:
means for generating power values for the sound signal and the echo signal;
means for determining a ratio of the power values; and
means for comparing the ratio to a reference to generate the detection signal.

18. The apparatus of claim 17, the means for generating the power values configured to calculate root mean square (RMS) values for the sound signal and the echo signal.

19. The apparatus of claim 17, the reference is a selected power level.

20. An apparatus comprising:
a first processor configured to receive a sound signal and generate a processed sound signal;
a second processor configured to receive an echo signal and generate a processed echo signal; and
a third processor configured to generate a detection signal the indicates whether or not a headset is in-use based on at least one of the processed sound signal and the processed echo signal.
